(19) United States
(12) Patent Application Publication
(10) Pub. No.: US 2017/0037973 A1
(43) Pub. Date: Feb. 9, 2017

(54) SEAL FOR A VALVE AND VALVE INCORPORATING SUCH A SEAL

(71) Applicant: SAINT-GOBAIN PERFORMANCE PLASTICS FRANCE, Charny (FR)

(72) Inventors: Roland LUCOTTE, Bussieres (FR); Gerald LAURENT, Verosvres (FR)

(21) Appl. No.: 15/122,791

(22) PCT Filed: Dec. 27, 2013
(86) PCT No.: PCT/EP2013/078095

§ 371 Date: Aug. 31, 2016

Related U.S. Application Data
(60) Provisional application No. 61/806,633, filed on Mar. 29, 2013.

(30) Foreign Application Priority Data
Dec. 28, 2012 (FR) 1262917

(51) Int. Cl. F16K 1/226

(52) U.S. Cl. CPC F16K 1/2265

(57) ABSTRACT

A seal (6), which is intended for a valve (1) comprising a body (3) and a shutter element (4) movable in a bore (31) of the body under an action of a drive shaft (5), includes at least one elastomeric ring segment (8) having a passage opening (81, 83) for the drive shaft (5). The elastomeric ring segment comprises a surrounding portion (82, 84) arranged around the passage opening (81, 83) and lateral arms (86, 88) which extend in the circumferential direction of the ring while being each connected to the surrounding portion. Starling from each junction (89) between the surrounding portion (82, 84) and a lateral arm (86, 88), the surrounding portion flares outwardly in an axial direction (X-X′) of the ring relative to the lateral arm.

The present invention relates to a seal for a valve, particularly a butterfly valve, comprising a body and a shutter movable in a bore of the body under the action of a drive shaft. The invention also relates to a valve comprising such a seal.

It is known to use a butterfly valve to control the flow of a fluid in pipes. To this end, the valve comprises a shutter element, or butterfly, rotatably mounted in a bore of the valve body between a closed position for closing the bore and an open position of free movement of the fluid in the bore. The shutter element is operated between its open and closed positions by means of a drive shaft which passes through the valve body. Such a valve must guarantee the sealing around the shutter element when in its closed position but also the sealing towards the exterior, both at the connection with the upstream and downstream pipes and at each passage of the drive shaft. In particular, when a valve is installed on a network conveying a fluid under pressure, no leakage to the outside is allowed,

To ensure all the sealings necessary for the valve, it is conventional to position a seal against the inner wall of the bore of the valve body. This seal may be formed by a sleeve made of elastomer. Alternatively, particularly in the case of corrosive or aggressive fluids, the seal may be formed by a sleeve made of plastomer, which is then surrounded on its outer periphery with an elastomeric ring for creating the pressure necessary for sealing. The sleeve, and optionally the associated elastomeric ring, are pierced with orifices for the passage of the drive shaft of the shutter element.

When the shutter element is in an open position, the periphery thereof is oriented substantially parallel to the axial direction of the bore to permit the flow of fluid. In this position, the shutter element biases the elastomer of the seal only in the vicinity of the drive shaft. This results in an inhomogeneous compression of the elastomer, which is highly compressed in the vicinity of the passages of the drive shaft and non-compressed in the rest of its periphery. The elastomer, which behaves like a highly viscous fluid, tends to flow from the compressed areas to the non-compressed areas, which causes a decrease in the contact pressure between the seal and the shutter element at the shaft passages and thus a risk of leakage around the shaft.

Several solutions have been proposed to prevent leakage around the shaft. One of them consists in providing, at each shaft passage, an additional elastomeric washer which is held compressed towards the shutter element by a set of spring washers. However, the presence of these additional washers complicates the structure and assembly of the valve. In particular, the introduction of additional washers requires an assembly in the longitudinal direction of the shaft, which prevents the insertion of the sleeve by sliding in the valve body and preferably requires a two-part body structure. This increases the time and cost of manufacturing the valve.

It is these drawbacks that the invention intends more particularly to remedy by proposing a seal for a valve that provides reliable and durable sealing of the valve, especially at each shaft passage, while having a simple structure allowing easy assembly and disassembly of the valve.

To this end, a subject of the invention is a seal for a valve comprising a body and a shutter element movable in a bore of the body under the action of a drive shaft, said seal being intended to be positioned in the bore of the body and configured to ensure the sealing of the valve at the shaft passages in the body, the seal comprising at least one elastomeric ring segment having a passage opening for the shaft, the elastomeric ring segment comprising a surrounding portion arranged around the passage opening and lateral arms which extend in the circumferential direction of the ring while being each connected to the surrounding portion, characterized in that, starting from each junction between the surrounding portion and a lateral arm, the surrounding portion flares outwardly in the axial direction of the ring relative to the lateral arm.

The fact that the surrounding portion flares outwardly in the axial direction of the ring starting from each junction with a lateral arm means that the width of the surrounding portion is, starting from each junction with a lateral arm, increased with respect to the width of the junction, where the widths are taken in the axial direction of the ring. In the context of the invention, this increase of the width of the surrounding portion is at least locally, for a portion of the surrounding portion adjacent to the junction, without excluding that the width of the surrounding portion can then decrease or remain constant. For example, the invention includes a configuration in which the surrounding portion is of square or rectangular shape around the orifice and two lateral arms are connected to two opposite sides of the surrounding portion while each having a width, in the axial direction of the ring, lower than that of the sides of the surrounding portion to which they are attached. In this case, the width of the surrounding portion is, starting from each junction with a lateral arm, increased relative to the width of the junction, and then remains constant.

With this flared configuration of the surrounding portion relative to the lateral arms, creep of the elastomer is prevented in the circumferential direction of the ring away from the shaft passage opening. Indeed, with this specific geometry, a stress funnel is created at each junction between the surrounding portion and a lateral arm, at which the stress lines converge. This results in areas of stress concentration on both sides of the surrounding portion in the circumferential direction, which form barriers to creep of the elastomeric material. In this way, the sealing of the valve at the shaft passages is guaranteed in a reliable and durable manner, playing only on the geometry of the elastomeric ring. In particular, this improved sealing is achieved without adding additional components, while maintaining a simple structure of the valve. This facilitates the assembly and disassembly of the valve, while limiting its manufacturing time and cost. Advantageously, a seal according to the invention allows an assembly with a valve body in one piece, by simply sliding the seal in the bore of the body.

The inventors have found that the creep resistance of the elastomer is even more efficient in cases where the stress funnel is narrow. In practice, the stress funnel can be made narrower by minimizing the width, taken along the axial direction of the ring, of the junction between the surrounding portion and the lateral arm, while maintaining a sufficient material quantity to ensure the sealing.

In one aspect of the invention, the end of each lateral arm which is connected to the surrounding portion has a width, taken along the axial direction of the ring, which decreases towards the surrounding portion, so that the junction between the surrounding portion and the lateral arm is a throttle in the axial direction of the ring. In other words, each junction between the surrounding portion and a lateral arm is a zone of smaller width in the axial direction of the ring, than the end of the surrounding portion and the end of the lateral arm which are immediately adjacent. This configuration enhances the effect of convergence of the stress lines by creating a stress funnel with double flare, one directed towards the surrounding portion and the other one towards the lateral arm.

The inventors have observed that this geometry with double flare helps to increase the creep resistance of the elastomer in the circumferential direction of the ring and therefore the sealing of the valve at the shaft passages. It was observed that by replacing an elastomeric ring having a geometry with single flare by an elastomeric ring having a geometry with double flare, where the elastomeric ring is in each case a complete ring with two shaft passage openings diametrically opposed and two surrounding portions each arranged around an opening, all other characteristics of the valve being otherwise kept unchanged, it is possible to obtain a gain of about 20% to 30% in terms of static pressure of the valve.

According to an advantageous feature, the surrounding portion has a circular shape around the shaft passage opening. This results in concentric forces applied on the surrounding portion, which tends to bring the elastomeric material in the direction of the shaft passage. In particular, during clamping of the valve between pipe sections, the compressive forces exerted on the ring segment in the radial direction of the ring generate compressive forces in the axial direction of the ring which, due to the circular shape of the surrounding portion, are redistributed concentrically around the shaft passage.

According to one characteristic, the elastomeric ring segment has a constant thickness in the radial direction of the ring.

Alternatively, the thickness of the surrounding portion in the radial direction of the ring can be greater than that of each lateral arm, which contributes to increasing the sealing of the valve at the shaft passages.

Optionally, the thickness of each lateral arm in the radial direction of the ring may decrease away from the surrounding portion, which promotes the axial creep of the elastomer and improves the torque for closing the valve as the shutter element has more space to reach its closed position.

In one aspect of the invention, the seal comprises a washer or set of washers arranged facing the outer surface of the surrounding portion. This or these washers exert a resilient thrust on the surrounding portion towards the shutter element parallel to the axis of the shaft, thereby improving the sealing. It can be spring washers, for example Belleville washers. Preferably, and in particular to limit the number of individual pieces to be put together during assembly of the valve, the washer(s) are fixed to the elastomeric ring segment prior to assembly of the valve. Advantageously, the elastomeric ring segment is molded onto the washer or set of washers. Alternatively, the washer(s) can be fixed to the elastomeric ring segment by any other suitable technique, especially by bonding or welding.

In one aspect of the invention, the or each elastomeric ring segment belongs to a complete elastomeric ring intended to be positioned in the bore of the body. This elastomeric ring advantageously comprises two diametrically opposed shaft passage openings and two surrounding portions each arranged around an opening.

In one aspect of the invention, the seal includes an annular plastomeric sleeve having at least one shaft passage opening, the or each elastomeric ring segment surrounding an outer peripheral surface of the sleeve with the opening of the elastomeric ring segment facing the opening of the sleeve.

According to an advantageous feature, the sleeve includes a collar projecting from its outer peripheral surface around the shaft passage opening and the surrounding portion of the elastomeric ring segment surrounds the collar. The collar may be integral with the sleeve. Alternatively, the collar can be attached to the collar, being secured therewith by any suitable means, including by fitting, bonding or welding, which facilitates the machining of the sleeve.

The sleeve comprises a tubular portion intended to be positioned in the bore of the valve body,

In a first embodiment, this tubular portion is cylindrical, in particular cylindrical with a circular cross-section.

In a second embodiment, this tubular portion includes:

a middle portion adapted to cooperate in a contiguous manner with the shutter element when it is in the closed position, and

two side portions on either side of the middle portion, wherein the inner surface of each side portion has at least one inclined surface portion, plane or curved, which is inclined with respect to the central axis of the tubular portion so as to come closer to the central axis towards the middle portion.

Within the meaning of the invention, an inclined surface portion may be a plane or curved surface, it being understood that the angle of inclination of a curved surface with respect to the central axis of the tubular portion is defined, at each point of the curved surface, by the angle of inclination of the plane tangent to the curved surface with respect to the central axis of the tubular portion. The definition given above of the side portions includes the case where each side portion has a plane inner surface inclined with respect to the central axis of the tubular portion so as to come closer to the central axis towards the middle portion. The definition given above of the side portions also includes the case where each side portion has an arcuate inner surface, which comes closer to the central axis towards the middle portion. In the latter case, the angle of inclination of the arcuate surface with respect to the central axis of the tubular portion is defined, at each point of the surface, by the angle of inclination of the plane tangent to the arcuate surface with respect to the central axis of the tubular portion. In particular, the entire inner surface of the sleeve may be a continuous arcuate surface, both at the middle portion and side portions.

The or each inclined surface portion has an angle of inclination, with respect to the central axis of the tubular portion, of between 0° and 90°, preferably between 0° and 45°, the bounds of these ranges being excluded.

In the second embodiment, thanks to the specific geometry of the tubular portion of the sleeve with inclined surface portions, centering of the forces is improved. Indeed, the forces exerted by the fluid flowing through the valve on the inclined surface portions contribute to compress the or each elastomeric ring segment arranged on the outer peripheral surface of the sleeve, and thus to improve the sealing of the valve. In particular, at each shaft passage, the forces exerted by the fluid on the inclined surface portions tend to compress the elastomeric ring segment around the shaft. In addition, with respect to the first embodiment in which the tubular portion is cylindrical, the provision of a plastomeric sleeve manufactured directly with inclined surface portions makes it possible to retrieve the energy of the fluid to compress the elastomeric ring, without prior energy loss to deform the sleeve.

According to an advantageous feature, the periphery of the sleeve has a U cross-section, the bottom of the U being formed by the said tubular portion and the side wings of the U being intended to bear against two opposite sides of the valve body in the vicinity of the bore, so that the valve body is enclosed by the sleeve on the periphery of the bore.

In one aspect of the invention, the or each elastomeric ring segment is received in a groove whose side edges follow the shape of the contour of the elastomeric ring segment. Advantageously, the spacing between the side edges of the groove is configured so as to leave a free volume around the elastomeric ring segment in the axial direction of the ring. Thus, the seal permits expansion of the elastomeric ring in the groove, which may be necessary in certain operating conditions of the valve, for example due to the forces exerted by the fluid flowing through the valve, or else due to a difference in thermal expansion coefficient between the elastomer constituting the ring segment and the material of the part in which the groove is formed, in particular the plastomer of the sleeve when the groove is arranged thereon.

Preferably, the spacing between the side edges of the groove may be configured such that, when the elastomeric ring segment is received in the groove, the volume left free in the axial direction of the ring around the surrounding portion is smaller than the volume left free in the axial direction of the ring around each lateral arm, away from the junction between the surrounding portion and the lateral arm. With such a shape of the groove which more closely surrounds the surrounding portion of the elastomeric ring segment, the compression of the elastomeric ring segment around the shaft is increased.

According to an embodiment of the invention, the groove is provided on the outer peripheral surface of the sleeve. In this case, the groove can be cut into the plastomeric material of the sleeve. Alternatively, the side edges of the groove may be formed by annular parts added on to the outer peripheral surface of the sleeve. This last variant makes it possible to render the sleeve thinner in its radial direction, so that it can move better to make room for the elastomer that surrounds it.

According to another embodiment of the invention, the groove is provided on the inner peripheral surface of the bore of the valve body. In this case, the groove may be formed directly in the body, particularly while it is being manufactured by molding. Alternatively, as previously, the side edges of the groove may be formed by annular parts added on to the inner peripheral surface of the bore of the valve body.

Whatever the embodiment, the spacing between the annular parts is advantageously adjustable, so as to modulate the free volume around the elastomeric ring segment. This free volume can then be adjusted according to the operating conditions of the valve and the expected expansion of the elastomeric ring segment, where it can be a thermal expansion or expansion caused by the forces exerted by the fluid flowing through the valve.

Another subject of the invention is a seal for a valve comprising a body and a shutter element movable in a bore of the body under the action of a drive shaft, said seal comprising a plastomeric sleeve of which a tubular portion is intended to be positioned in the bore of the body, the tubular portion comprising:

a middle portion adapted to cooperate in a contiguous manner with the shutter element when it is in the closed position, and

two side portions on either side of the middle portion, wherein the inner surface of each side portion has at least one inclined surface portion, plane or curved, which is inclined with respect to the central axis of the tubular portion so as to come closer to the central axis towards the middle portion.

Within the meaning of the invention, an inclined surface portion may be a plane or curved surface, it being understood that the angle of inclination of a curved surface with respect to the central axis of the tubular portion is defined, at each point of the curved surface, by the angle of inclination of the plane tangent to the curved surface with respect to the central axis of the tubular portion.

The definition given above of the side portions includes the case where each side portion has a plane inner surface, which is inclined with respect to the central axis of the tubular portion so as to come closer to the central axis towards the middle portion.

The definition given above of the side portions also includes the case where each side portion has an arcuate inner surface, which comes closer to the central axis towards the middle portion. In the latter case, the angle of inclination of the arcuate surface with respect to the central axis of the tubular portion is defined, at each point of the surface, by the angle of inclination of the plane tangent to the arcuate surface with respect to the central axis of the tubular portion. In one particular embodiment, the entire inner surface of the sleeve may be a continuous arcuate surface, both at the middle portion and side portions, the concavity of this arcuate surface facing away from the central axis of the tubular portion so that the inner surface of the sleeve is closest to this axis at the middle portion.

The or each inclined surface portion has an angle of inclination, with respect to the central axis of the tubular portion, of between 0° and 90°, preferably between 0° and 45°, the bounds of these ranges being excluded.

Such geometry of the tubular portion of the sleeve which, as explained above, favors the compression, at the middle portion of the sleeve, of an elastomeric ring or of elastomeric ring segments placed on the outer peripheral surface of the sleeve, can be considered independently and for any geometry of the elastomeric ring or elastomeric ring segments. In particular, such a geometry of the sleeve with inclined surface portions can be set up even when the sleeve is associated with an elastomeric ring or elastomeric ring segments which do not have a stress funnel obtained with a flared configuration of their surrounding portions with respect to the lateral arms.

The invention also relates to a valve comprising a body and a shutter element movable in a bore of the body under the action of a drive shaft, said valve comprising a seal as described above, which is positioned in the bore of the body.

The features and advantages of the invention will become apparent from the following description of four embodiments of a seal and a valve according to the invention, given solely by way of example and made with reference to the appended drawings in which:

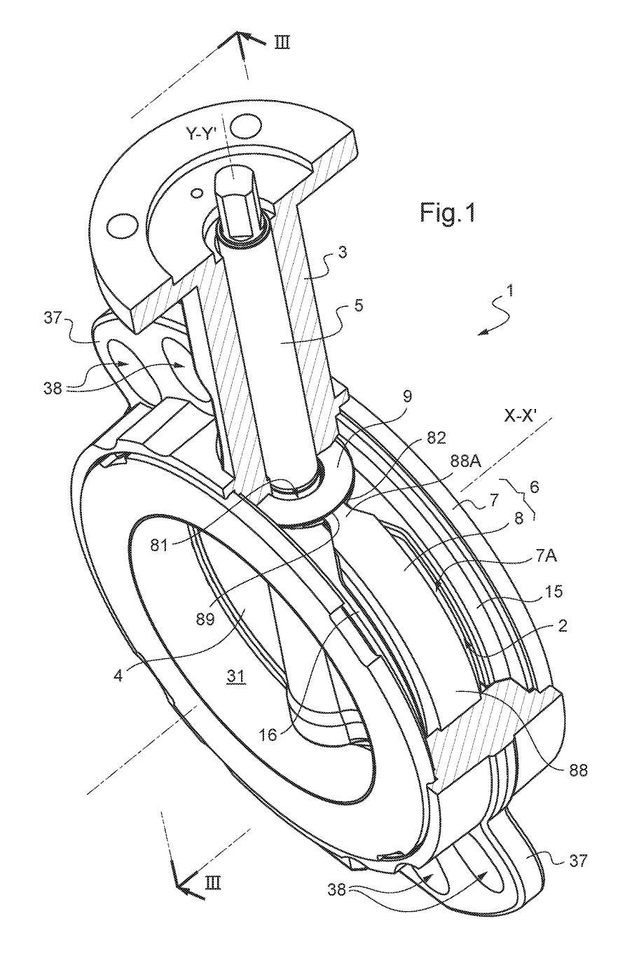

FIG. 1 is a perspective view of a valve according to a first embodiment of the invention, the valve body being partially omitted;

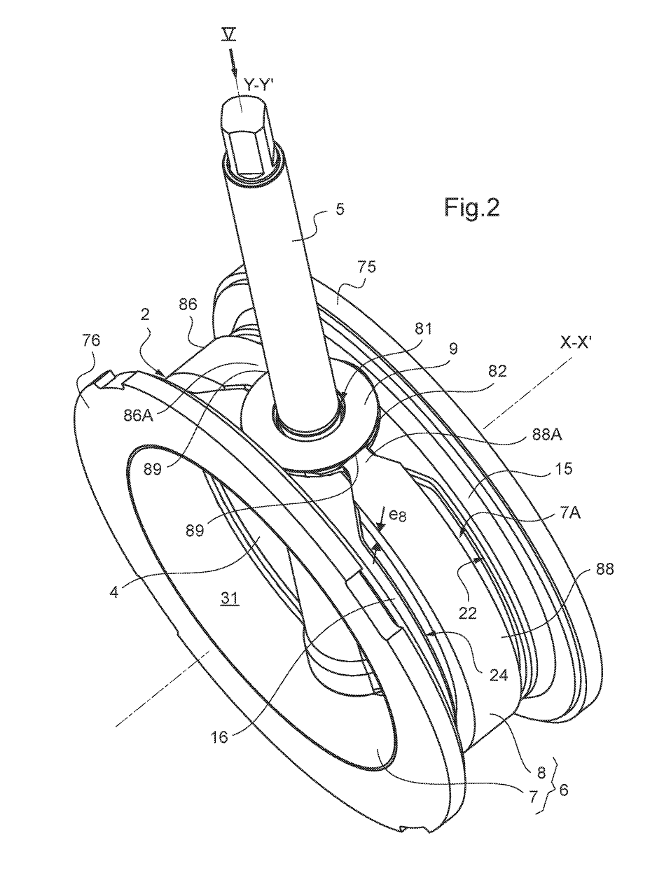

FIG. 2 is a view similar to FIG. 1 without the valve body;

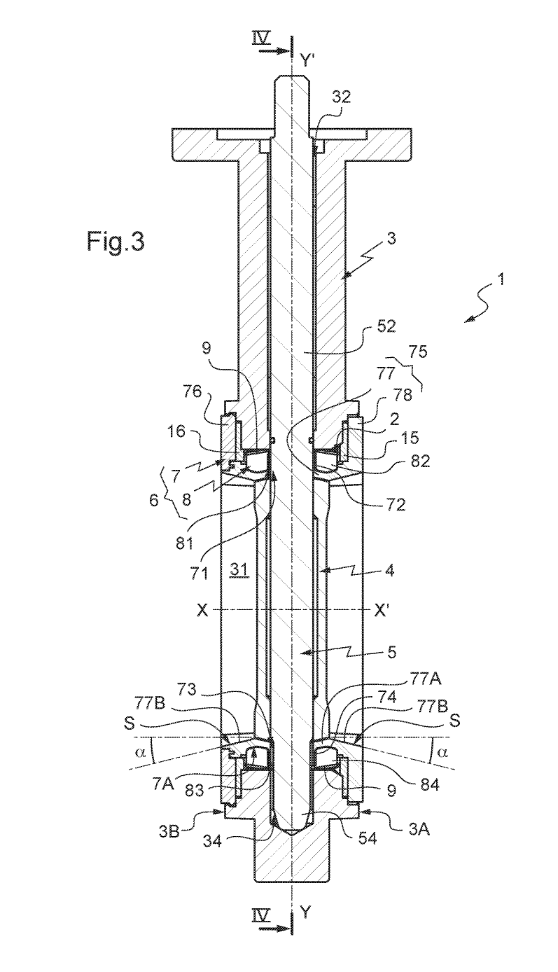

FIG. 3 is a cross section along the plane III of FIG. 1;

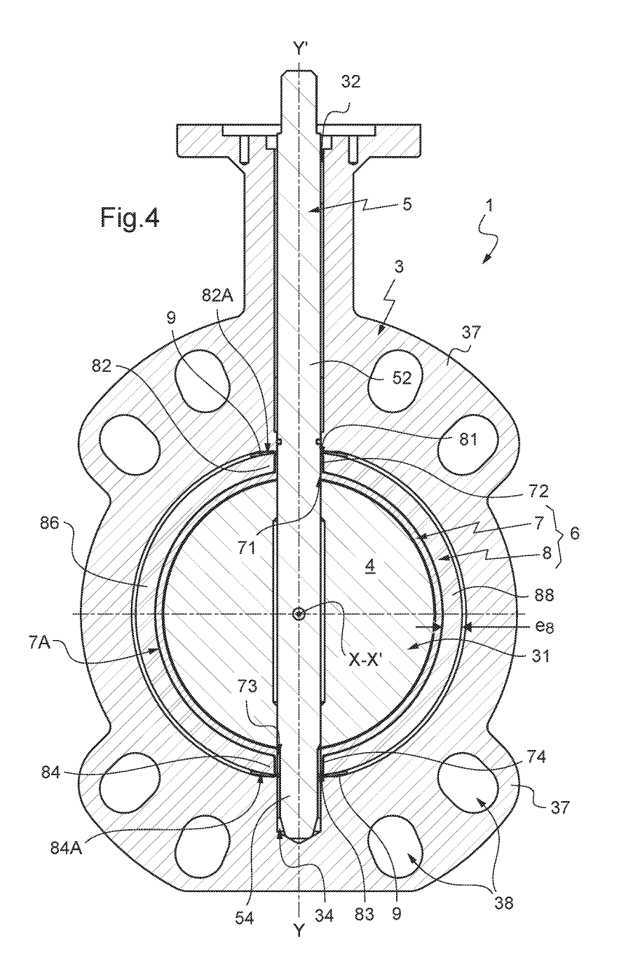

FIG. 4 is a cross section along the line IV-IV of FIG. 3;

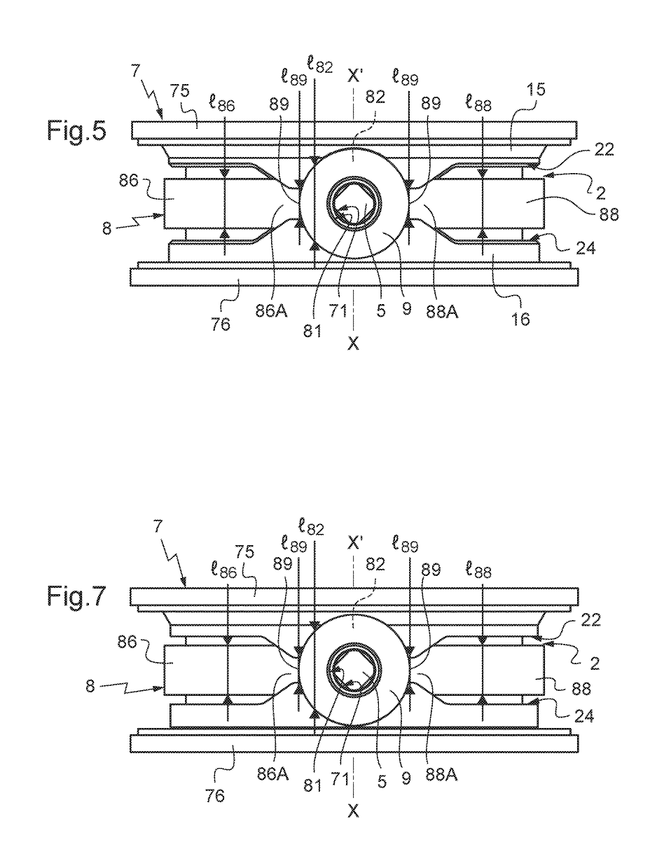

FIG. 5 is a top view in the direction of the arrow V of FIG. 2;

FIG. 6 is a perspective view similar to FIG. 2 for a valve according to a second embodiment of the invention;

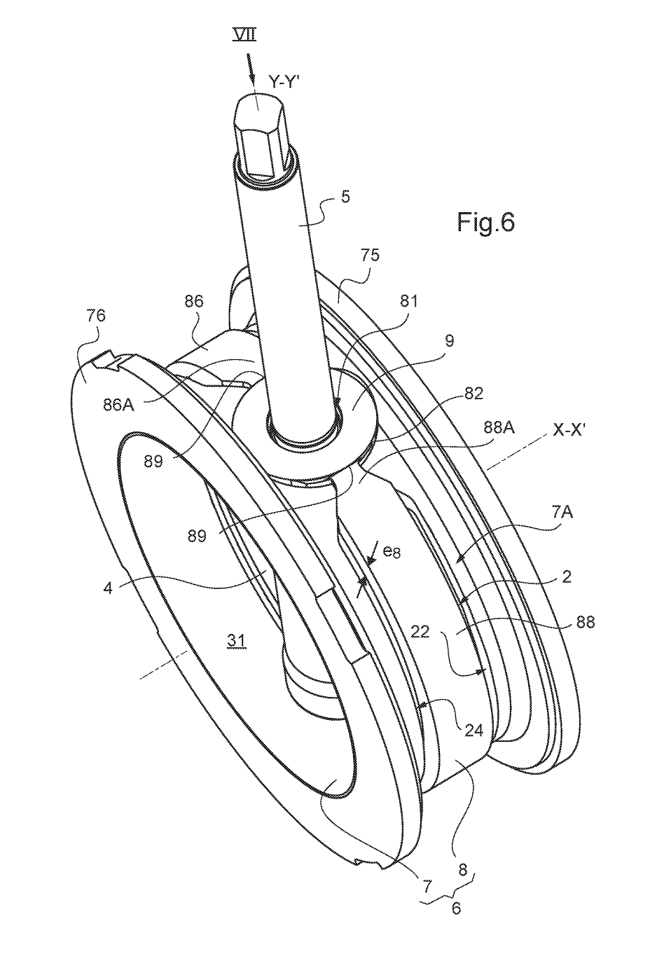

FIG. 7 is a top view in the direction of the arrow VII of FIG. 6;

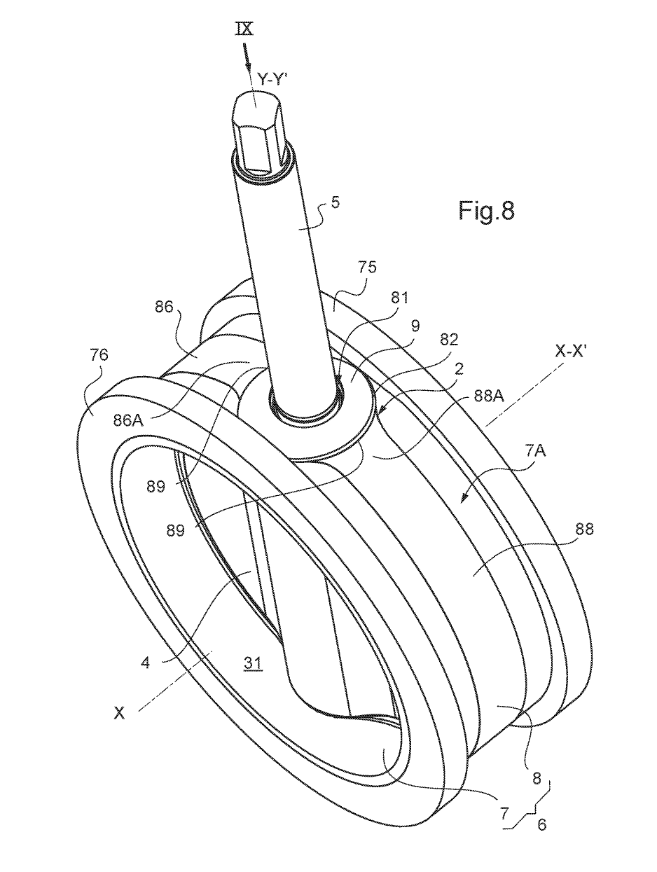

FIG. 8 is a perspective view similar to FIG. 2 for a valve according to a third embodiment of the invention;

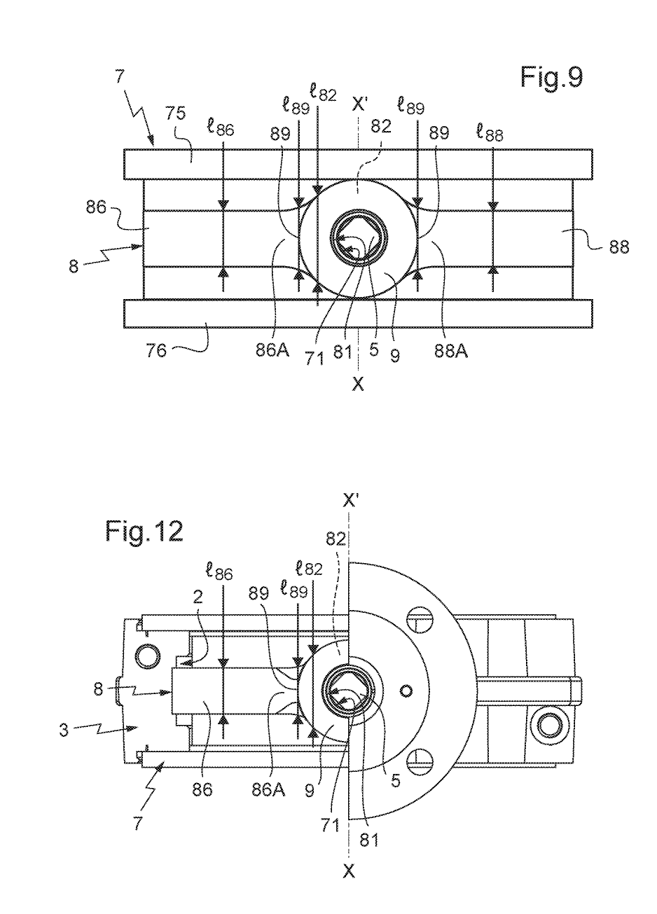

FIG. 9 is a top view in the direction of the arrow IX of FIG. 8;

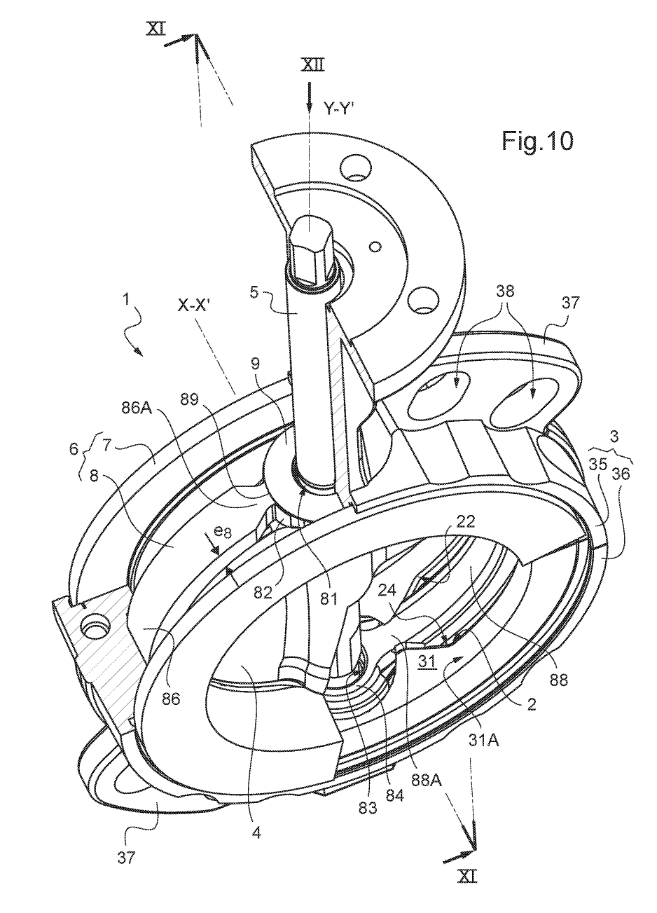

FIG. 10 is a perspective view of a valve according to a fourth embodiment of the invention, the valve body being partially omitted;

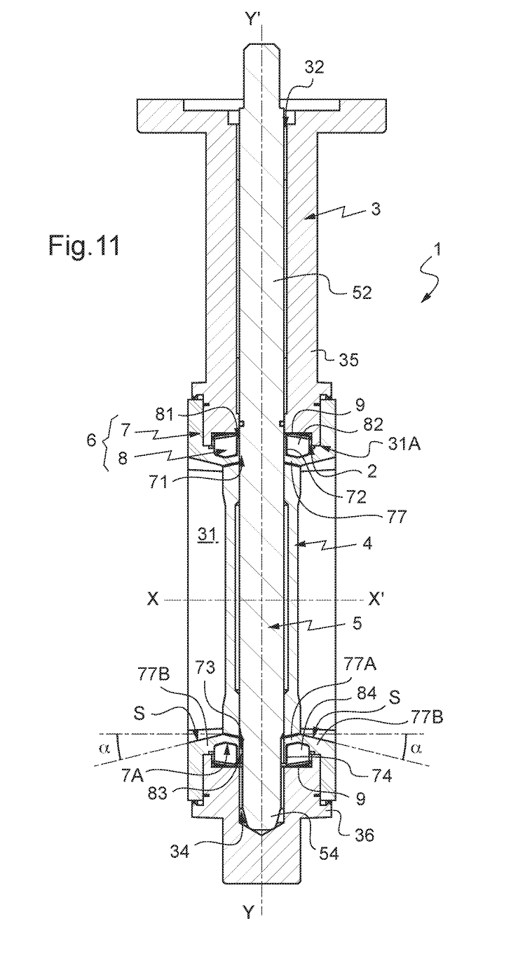

FIG. 11 is a cross section along the plane XI of FIG. 10; and

FIG. 12 is a top view in the direction of the arrow XII of FIG. 10.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present),

Also, the use of “a” or “an” is employed to describe elements and components described herein. This is done merely for convenience and to give a general sense of the scope of the invention. This description should be read to include one or at least one and the singular also includes the plural unless it is obvious that it is meant otherwise.

Various embodiments of the present disclosure will now be described, by way of example only, with reference to the accompanying drawings.

In the first embodiment shown in FIGS. 1 to 5, the butterfly valve 1 includes a valve body 3, a shutter element (or butterfly) 4 rotatably mounted in a bore 31 of the body 3, and a shaft 5 whose function is to rotate the shutter element 4 between an open position and a closed position and to keep it in position. In the figures, the shutter element 4 is shown in the closed position. In this first embodiment, the valve body 3 is integral, that is to say, constructed in one piece. The valve 1 also comprises a seal 6 of annular shape, positioned in the bore 31 so as to ensure all scalings necessary for the valve. X-X denotes the central axis of the bore 31, which is of circular cross-section, and Y-Y′ denotes the longitudinal axis of the shaft 5. The axes X-X′ and Y-Y′ are substantially perpendicular to each other.

As is clearly visible in the cross sections of FIGS. 3 and 4, the shaft 5 passes through the shutter element 4 from top to bottom and is rotatably mounted at its upper end 52 and lower end 54, respectively, in an upper neck 32 and a lower neck 34 of the valve body 3. The valve 1 is intended to be clamped between upstream and downstream pipe sections fitted with flanges, not shown in the figures. To this end, the body 3 has two circumferential flanges 37 each having a series of holes 38. These holes 38 are intended to receive a series of bolts for clamping the valve 1 between opposed flanges of pipe sections to be assembled.

The seal 6 comprises an annular sleeve 7 of circular cross-section, which can be made of a plastomeric material resistant to corrosive fluids, in particular a fluoropolymer such as polytetrafluoroethylene (PTFE). The periphery of the sleeve 7 has a U cross-section, which encloses the body 3 on the periphery of the bore 31. In this first embodiment, the sleeve 7 is in two parts 75 and 76, wherein the part 75 comprises a tubular portion 77 of circular cross-section, forming the bottom of the U, and a lateral portion 78, forming a side wing of the U, while the part 76 forms the other side wing of the U. 7A denotes the outer peripheral surface of the tubular portion 77. The tubular portion 77 is intended to be positioned in the bore 31 of the body 3 of the valve, the wings 76 and 78 then coming to bear against two opposite sides 3A and 3B of the body 3 where the bore 31 opens. When the tubular portion 77 is positioned in the bore 31, its central axis is coincident with the axis X-X′.

As is clearly visible in the cross section of FIG. 3, the tubular portion 77 of the sleeve 7 has a middle portion 77A which is adapted to cooperate in a contiguous manner with the shutter element 4 when it is in the closed position, and two side portions 773 on either side of the middle portion 77A. In this embodiment, the inner peripheral surface S of each of the two side portions 773 is plane and inclined at an angle a relative to the central axis of the tubular portion 77, where said central axis is coincident with the axis X-X′ in FIG. 3, so as to become closer to the central axis in the direction of the middle portion 77A. The angle a of inclination of the inner surface S of each side portion 77B with respect to the central axis of the tubular portion 77 is preferably between 10° and 30°, it being understood that the preferred value of the angle a depends on the shape and the size of the valve. The sleeve 7 can be made, in particular, by molding.

The seal 6 also comprises an elastomeric ring 8, for example made of silicone, which surrounds the outer peripheral surface 7A of the sleeve 7 and provides the seal 6 with elasticity properties. The tubular portion 77 of the sleeve 7 and the elastomeric ring 8 are each pierced with two diametrically opposite openings, provided for the passage of the drive shaft 5. More specifically, the tubular portion 77 of the sleeve comprises an upper opening 71, respectively a lower opening 73, from which an upper collar 72, respectively a lower collar 74, extends projecting from the outer peripheral surface 7A. The elastomeric ring 8 has an upper opening 81 positioned facing the opening 71 of the sleeve while surrounding the collar 72 and a lower opening 83 positioned facing the opening 73 of the sleeve while surrounding the collar 74. The shaft 5 passes inside the collars 72 and 74 of the sleeve 7, which are pressed in contact against the shaft by the elastomer of the ring 8 that surrounds them. Advantageously, the forces exerted on the inner surfaces S of the side portions 77B of the sleeve 7 by the fluid flowing through the valve 1 tend to compress the elastomeric ring 8 in the middle portion 77A of the sleeve, which favors the sealing of the valve.

The elastomeric ring 8 comprises, around each upper opening 81 and lower opening 83, a surrounding portion, respectively upper surrounding portion 82 and lower surrounding portion 84, which has a circular shape around the opening. The elastomeric ring 8 also comprises two lateral arms 86 and 88, where each lateral arm connects the two surrounding portions 82 and 84 in the circumferential direction of the ring 8. l₈₂, l₈₄ denote the respective widths of the surrounding portions 82 and 84, and l₈₆, l₈₈ denote the respective widths of the lateral arms 86 and 88, taken along the axial direction of the ring 8. The axial direction of the ring 8 is that of the axis X-X′. By extension, it will be called hereafter “the axial direction X-X′”.

As seen in the top view of FIG. 5, it being understood that a bottom view would be identical, each junction 89 between a surrounding portion 82 or 84 and a lateral arm 86 or 88 is a throttle along the axial direction X-X′ of the ring 8. In other words, each junction 89 between a surrounding portion and a lateral arm is an area whose width l₈₅, in the axial direction X-X′, is less than those of the end of the surrounding portion and the end of the lateral arm adjacent thereto. Thus, for each junction 89 shown in FIG. 5, the width l₈₆ or l₈₈ of the end 86A or 88A of the lateral arm decreases towards the junction 89, while the width l₈₂ of the surrounding portion 82 increases starting from the junction 89. According to the invention, this configuration prevents creep of the elastomer in the circumferential direction of the ring 8 away from the shaft passage opening 81 or 83, creating at each junction 89 a stress funnel with double flare, in which the stress lines converge.

In this embodiment, the elastomeric ring 8 has a thickness l₈ that is constant in the radial direction of the ring. Alternatively, in order to further improve the sealing of the valve at the passages of the shaft 5, it can be advantageous for the thickness of each surrounding portion 82 and 84 in the radial direction of the ring to be greater than that of each lateral arm 86 and 88 and/or for the thickness of each lateral arm 86 and 88 in the radial direction of the ring to decrease away from the surrounding portions 82 and 84.

The elastomeric ring 8 is received in a groove 2 provided on the outer peripheral surface 7A of the sleeve 7, whose side edges 22 and 24 follow the shape of the contour of the elastomeric ring 8. Advantageously, the spacing between the side edges 22 and 24 of the groove 2 can be adjusted so as to leave a free volume around the elastomeric ring 8 in the axial direction X-X′. Thus, the seal 6 allows for axial expansion of the elastomeric ring 8 in the groove 2.

In embodiments, the spacing between the side edges 22 and 24 of the groove 2 is adapted such that when the ring 8 is received in the groove 2, the volume left free in the axial direction X-X′ around the surrounding portions 82 and 84 is smaller than the volume left free in the axial direction X-X around the lateral arms 86 and 88 away from the junction 89. With such a shape of the groove 2, which more closely surrounds the surrounding portions 82 and 84, the compression of the elastomeric ring 8 around the shaft 5 is increased.

In this first embodiment, the side edges 22 and 24 of the groove 2 are formed by two annular parts 15 and 16 which are added on to the outer peripheral surface 7A of the sleeve. According to an advantageous aspect, not shown, the valve 1 may comprise means for adjusting the spacing between the annular parts 15 and 16, so as to modulate the volume left free in the axial direction X-X′ around the elastomeric ring 8 and thus adjust it according to the service conditions of the valve.

As is clearly visible in the cross sections of FIGS. 3 and 4, the seal 6 further comprises two spring washers 9, one positioned facing the outer surface 82A of the upper surrounding portion 82 and the other facing the outer surface 84A of the lower surrounding portion 84, each being centered on the shaft passage opening 81 or 83. Each washer 9 exerts on the corresponding surrounding portion 82 or 84 an elastic thrust towards the shutter element 4, parallel to the axis Y-Y of the shaft 5, which reinforces the sealing. Advantageously, a free volume is provided in the radial direction between each washer 9 and the inner surface of the bore 31 which faces it, so as to allow expansion of the elastomeric ring 8 parallel to the axis Y-Y′.

This free volume can result from a conical shape of the washer received in a cylindrical space, as is the case for the spring washers 9 of conical shape which are each received in a cylindrical space bounded laterally by the annular parts 15 and 16. Alternatively, and especially when the washer is not conical in shape, this free volume can result from the presence of a groove or a toothed form in the body 3 facing the washer.

Preferably, the two washers 9 are secured to the elastomeric ring 8 prior to assembly of the valve 1, which facilitates the assembly of the valve. Advantageously, the elastomeric ring 8 is molded onto the washers 9 during its manufacture, for example by molding. Alternatively, the washers 9 may be fixed to the elastomeric ring 8 by any other appropriate means, particularly by bonding or welding onto the surrounding portions 82 and 84.

The assembly of the valve 1 according to the first embodiment includes steps as described below.

Firstly, the shutter element 4 is placed in the internal volume of the tubular portion 77 of the first constituent part 75 of the sleeve 7, with the shaft passage openings of the shutter element 4 in correspondence with the openings 71 and 73 of the tubular portion 77, and a pin is inserted through the tubular portion 77 and the shutter element 4.

Then, the elastomeric ring 8, provided with its two washers 9, is positioned on the outer peripheral surface 7A of the tubular portion 77, taking care to position each of the openings 81, 83 of the ring 8 opposite the corresponding opening 71, 73 of the tubular portion 77, with the collar 72, 74 which passes through the opening 81, 83. The pin then comes out at the level of the two washers 9, without extending beyond them. Note that, alternatively, the pin could have been installed after the positioning of the elastomeric ring 8 on the outer peripheral surface 7A, and not before. The annular part 15 is also positioned on the outer peripheral surface 7A of the tubular portion 77.

The preformed assembly thus obtained, comprising the first part 75 of the sleeve 7, the elastomeric ring 8, the annular part 15, the shutter element 4 and the pin, is positioned facing the bore 31 of the valve body 3, on a first side 3A of the body 3. After checking the alignment of the axes of the shutter element 4 and the body 3, the preformed assembly is inserted in the bore 31 of the body 3, by sliding in the axial direction XX, for example using a press, until the abutment of the annular part 15 and the side wing 78 of the part 75 against the first side 3A of the body 3. In this inserted configuration of the preformed assembly in the bore 31, the coaxiality of the shutter element 4 and the body 3 is checked again and, if necessary, it is corrected by rotating the preformed assembly relative to the body 3.

Then, the pin is removed and the shaft 5 is inserted in its place, through the body 3, the part 75 and the shutter element 4. Before or after removal of the pin and the insertion of the shaft 5, the annular part 16 is positioned on the outer peripheral surface 7A of the tubular portion 77, bearing against the second side 3B of the body 3 opposite the first side 3A. Finally, the second part 76 constituting the sleeve 7 is connected with the first part 75. The second part 76 abuts against the second side 3B of the body 3, so that the body 3 is enclosed by the sleeve 7 on the periphery of the bore 31. In this configuration, the valve 1 is ready to be used.

In the second embodiment shown in FIGS. 6 and 7, elements similar to those of the first embodiment bear identical references. The valve 1 of this second embodiment differs from that of the first embodiment only in that the groove 2 for receiving the elastomeric ring 8 is cut directly into the plastomeric material of the sleeve 7, without the need to provide additional parts on the outer peripheral surface 7A of the sleeve.

In the third embodiment shown in FIGS. 8 and 9, elements similar to those of the first embodiment bear identical references. The valve 1 of this third embodiment differs from that of the second embodiment only by the geometry of its elastomeric ring 8. Indeed, in the third embodiment, the width l₈₆, l₈₈ of each end 86A, 88A of the lateral arms 86 and 88, taken along the axial direction X-X, does not decrease towards the corresponding surrounding portion 82 or 84. However, there is still a configuration of the elastomeric ring 8 such that, starting from each junction 89 between a surrounding portion and a lateral arm, the surrounding portion 82 or 84 flares in the axial direction X-X′ relative to the lateral arm 86 or 88. Thus, in this third embodiment, at each junction between a surrounding portion and a lateral arm, a stress funnel is obtained with a single flare towards the surrounding portion.

The assembly of the valves according to the second and third embodiments is performed in the same way as in the first embodiment, except that the annular parts 15 and 16 delimiting the groove 2 are absent and the elastomeric ring 8 is positioned directly into the groove 2 cut in the outer peripheral surface 7A of the tubular portion 77 of the first part 75 constituting the sleeve 7.

In the fourth embodiment shown in FIGS. 10 to 12, elements similar to those of the first embodiment bear identical references. The valve 1 of the fourth embodiment comprises an elastomeric ring 8 similar to those of the first and second embodiments, that is to say that each junction 89 between a surrounding portion 82 or 84 and a lateral arm 86 or 88 of the ring 8 is a throttle in the axial direction X-X′ of the ring. Thus, as explained above, a stress funnel with double flare is created at each junction 89, which prevents the creep of the elastomer in the circumferential direction of the ring 8 away from the shaft passage opening 81 or 83.

The valve 1 of the fourth embodiment differs from those of the previous embodiments in that, firstly, the groove 2 for receiving the elastomeric ring 8 is provided in the valve body 3, instead of being formed on the sleeve 7, and, secondly, the sleeve 7 is in one piece instead of being constituted by two parts 75 and 76, while the body 3 is in two parts 35 and 36 instead of being in one piece.

More specifically, the groove 2 is disposed on the inner peripheral surface 31A of the bore 31 of the valve body 3, and as in the previous embodiments, the side edges 22 and 24 of the groove 2 follow the shape of the contour of the elastomeric ring 8. Advantageously, the spacing between the side edges 22 and 24 of the groove 2 is adjusted so as to leave a free volume around the elastomeric ring 8 in the axial direction X-X′, to allow for axial expansion of the elastomeric ring 8 in the groove 2.

In embodiments, in order to increase the compression of the elastomeric ring 8 around the shaft 5, the spacing between the side edges 22 and 24 of the groove 2 is adapted such that when the ring 8 is received in the groove 2, the volume left free in the axial direction XX around the surrounding portions 82 and 84 is less than the volume left free in the axial direction XX′ around the lateral arms 86 and 88 away from the junction 89.

Note that, as shown in the cross section of FIG. 11, the tubular portion 77 of the sleeve 7 in one piece of this fourth embodiment still comprises a middle portion 77A and two side portions 77B on either side of the middle portion 77A, where the inner peripheral surface S of each of the two portions 77B is inclined at an angle u relative to the central axis of the tubular portion 77 so as to come closer to the central axis in the direction of the middle portion 77A. In this embodiment, the angle a of inclination of the inner surface S of each side portion 77B with respect to the central axis of the tubular portion 77 is preferably between 10° and 30°, such as about 20°.

The assembly of the valve 1 according to the fourth embodiment includes steps as described below.

Firstly, the shutter element 4 is placed in the internal volume of the sleeve 7, with the shaft passage openings of the shutter element 4 in correspondence with the openings 71 and 73 of the sleeve.

Then, the elastomeric ring 8, provided with its two washers 9, is positioned on the outer peripheral surface 7A of the sleeve 7 in one piece, taking care to position each of the openings 81, 83 of the ring 8 facing the corresponding opening 71, 73 of the sleeve, with the collar 72, 74 passing in the opening 81, 83.

Before or after the positioning of the elastomeric ring 8 on the outer peripheral surface 7A, the shaft 5 is inserted through the sleeve 7 and the shutter element 4.

The preformed assembly thus obtained, comprising the sleeve 7, the elastomeric ring 8, the shutter element 4 and the shaft 5, is positioned in the half-bore 31 formed by the lower part 36 of the valve body 3, inserting the lower end 54 of the shaft 5 in the neck 34 of the part 36. The elastomeric ring 8 is then received in the half-groove 2 defined by the lower part 36 of the body.

The upper part 35 of the body 3 is then attached to the lower part 36, by inserting the upper end 52 of the shaft 5 in the neck 32 of the part 35 and by ensuring that the elastomeric ring 8 is well received in the half-groove 2 defined by the upper part 35 of the body. The two parts 35 and 36 of the body 3 are then secured by screwing. In this configuration, the valve 1 is ready to be used.

It should be noted that the configuration where the groove 2 for receiving the elastomeric ring 8 is arranged on the inner peripheral surface 31A of the valve body 3 is also possible with a valve body 3 in one piece, the sleeve 7 then being made in two separate parts 75 and 76 as in the previous embodiments.

Similarly, the configuration where the groove 2 for receiving the elastomeric ring 8 is arranged on the outer peripheral surface 7A of the sleeve 7, which has been described above with a valve body 3 in one piece and a sleeve 7 in two parts, is also possible with a valve body 3 in two parts 35 and 36, the sleeve 7 then possibly being in one piece.

In addition, when the valve body 3 is in two parts, the two parts of the body may be lateral parts instead of lower and upper parts as in the example of FIGS. 10 to 12. Indeed, the valve body 3 can be separated into two parts by cutting along a plane parallel to the plane defined by the axes X-X′ and YY. The screws for connecting the two lateral parts of the body 3 can then extend parallel to the axis X-X′.

It should also be noted that the groove 2 for receiving the elastomeric ring 8, when disposed on the inner peripheral surface 31A of the bore 31 of the body 3, can be formed directly in the body 3, especially during the manufacture of the body by molding, for example using a sand mold when the body is in one piece. According to a variant not shown, the edges of the groove 2 of the body 3 can be formed by annular parts added on to the inner peripheral surface 31A of the bore 31, similarly to what was described above with the annular parts 15 and 16 when the groove is arranged on the sleeve.

The invention is not limited to the examples described and shown.

In particular, a seal according to the invention may comprise only elastomeric ring segments at the shaft passages, instead of a complete elastomeric ring over the entire periphery of the bore of the valve body.

In addition, regardless of the embodiment, the elastomeric ring or elastomeric ring segment may comprise, on each side of a surrounding portion, a plurality of lateral arms extending in the circumferential direction of the ring. This makes it possible to limit the individual width of each arm in the axial direction of the ring.

Each surrounding portion of the elastomeric ring or of the elastomeric ring segment may also have a shape other than circular around the shaft passage opening, in particular an elliptical or polygonal shape, for example quadrilateral, without excluding shapes where the width of the surrounding portion in the axial direction of the ring increases starting from each junction with a lateral arm, forming a flared portion, and decreases in an intermediate portion between the flared portions.

In addition, a seal according to the invention may comprise, in place of spring washers as described above, any other type of washers able to exert an elastic thrust on the surrounding portion towards the shutter element. While this is less favorable, a seal according to the invention can also be devoid of washers at the surrounding portions.

In addition, it is noted that all the above examples involve a plastomeric sleeve whose tubular portion includes inclined surface portions at its side portions, so as to improve the centering of the forces and promote compression of the or each elastomeric ring segment positioned on the outer peripheral surface of the sleeve. However, according to the invention, elastomeric ring segments having a flared configuration of their surrounding portions relative to the lateral arms may be associated with a sleeve whose tubular portion does not have surface portions inclined with respect to the central axis of the tubular portion, in particular a sleeve whose tubular portion is cylindrical (angle of inclination a equal to 0⁰). Moreover, in the previous examples, the collars of the plastomeric sleeve are integral with the latter. However, the invention also encompasses the case where each collar of the sleeve is attached to the sleeve and secured to it by any appropriate means, including fitting, gluing or welding, the machining of the plastomeric sleeve then being facilitated.

The preceding embodiments illustrate cases where the groove for receiving the elastomeric ring is arranged either on the outer peripheral surface of the sleeve or on the inner peripheral surface of the bore of the valve body. However, it is also possible to have both a groove on the sleeve and a groove on the valve body, with two stackable elastomeric rings.

In the previous examples, the seal comprises a plastomeric sleeve surrounded on its outer periphery with an elastomeric ring which is used to create the necessary pressure for sealing. However, the invention can also be implemented for a seal which has no plastomeric sleeve. In particular, a seal according to the invention may be formed by a sealing sleeve made of elastomer, that is to say a complete elastomeric ring which comprises, around each shaft passage opening, a collar projecting outwardly intended to extend into the corresponding neck of the valve body, along the drive shaft. Thanks to its elastic properties, the elastomeric sleeve itself creates the pressure needed to seal the valve.

It should be noted that the elastomeric ring of a seal according to the invention, whether or not it is associated with a plastomeric sleeve, can be based on any suitable elastomeric material having properties adapted to its function, in particular selected from; silicone elastomers, such as, for example, elastomeric silicone of the type MQ (Methyl-Silicone), VMQ (Vinyl-Methyl-Silicone), PVMQ (Phenyl-Vinyl-Methyl-Silicone), FVMQ (Fluoro-Vinyl-Methyl-Silicone); natural rubber or cis-1,4-polyisoprene (NR); copolymers of butadiene and styrene (SBR); “synthetic natural rubber” or synthetic polyisoprene (IR); polybutadiene (BR); polyisobutylene or isobutylene-isoprene rubber, also called “butyl rubber” (PIB or IIR); chloroprene or neoprene (CR); butadiene-acrylonitrile copolymers or “nitrile rubber” (NBR); hydrogenated butadiene-acrylonitrile copolymers, also called “hydrogenated nitrile rubbers” (HNBR); ethylene-propylene copolymers (EP or EPM) and ethylene-propylene-diene terpolymers (EPDM); polyether block amide (PEBA); thermoplastic elastomers of the type EPDM-PP (trade name Santoprene); thermoplastic polyurethanes (TPU); thermoplastic olefins (TPO); polysulfides; fluoroelastomers of FPM or FKM type; perfluoroelastomer (FFKM); ethylene-vinyl acetate copolymers (EVA or EVM); polyacrylic elastomers (ACM); ethylene acrylic copolymers (AEM); chlorosulfonated polyethylenes (CSM); or epichlorohydrin elastomers (CO and ECO).

Similarly, when the seal comprises a plastomeric sleeve, the latter can be based on any plastomeric material having properties adapted to its function, particularly resistant to corrosion, for applications in corrosive environments, and/or removing any possibility of contamination, for high purity processes, in particular selected from: fluoropolymers, a term designating any polymer having in its chain at least one monomer selected from compounds containing a vinyl group capable of opening to polymerize and which contains, directly attached to this vinyl group, at least one fluorine atom, a fluoroalkyl group or a fluoroalkoxy group. As examples of monomer, mention may be made of vinyl fluoride; vinylidene fluoride (VF2); trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers, such as perfluoro(methyl vinyl)ether (PMVE), perfluoro(ethyl vinyl)ether (PEVE) and perfluoro(propyl vinyl)ether (PPVE), perfluoro (1,3-dioxole); perfluoro (2,2-dimethyl-1,3-dioxole) (PDD); the product of formula CF2=CFOCF2CF(CF3)OCF2CF2X wherein X is SO2F, CO2H, CH2OH, CH2OCN or CH2OPO3H; the product of formula CF2=CFOCF2CF2SO2F; the product of formula F(CF2)nCH2OOF=CF2 wherein n is 1, 2, 3, 4 or 5; the product of formula CF2=R1CH2OCF wherein R1 is hydrogen or F(CF2)z and z is 1, 2, 3 or 4; the product of formula R3OCF═CH2 wherein R3 is F(CF2)z- and z is 1, 2, 3 or 4; perfluorobutylethylene (PFBE); 3,3,3-trifluoropropene; 2-trifluoromethyl-3,3,3-trifluoro-1-propene. The fluoropolymer may be a homopolymer or a copolymer, it may also include non-fluorinated monomers such as ethylene. Advantageously, the fluoropolymer is selected from: fluorinated ethylene propylene (FEP), ethylene tetrafluoroethylene (ETFE), polytetrafluoroethylene perfluoropropyl vinyl ether (PFA), polytetrafluoroethylene perfluoromethyl vinyl ether (MFA), polytetrafluoroethylene (PTFE), polyvinylidene fluoride (PVDF), ethylenechlorotrifluoroethylene (ECTFE), polychlorotrifluoroethylene (PCTFE) or tetrafluoroethylene hexafluoropropylene vinylidene fluoride (THV), or a combination thereof. In particular, the fluoropolymer may be polytetrafluoroethylene (PTFE), such as a modified PTFE. In one example, the modified PTFE is a copolymer of tetrafluoroethylene and a vinyl ether, such as perfluoropropyl vinyl ether (PPVE). In one embodiment, the modified PTFE includes at least about 0.01% by weight of perfluoropropyl vinyl ether (PPVE). In another example, the modified PTFE includes no more than about 5.0% by weight of PPVE, such as no more than about 3.0% by weight or no more than about 1.5% by weight of PPVE. Although particular embodiments of the modified PTFE may include PPVE which are melt processable, a particularly useful modified PTFE includes a small amount of PPVE such that the modified PTFE cannot be melt processed and is, instead, usually deposited in solution and sintered. Specific examples of modified FIFE are commercially available such as TFM 1700 available from Dyneon, Teflon® NXT available from DuPont and M1-11 available from Daikon. High performance polymers alternative to fluoropolymers, such as high density polyethylene (HDPE), high molecular weight polyethylene (PEUHMW), polyether ether ketone (PEEK), poly(phenylene sulfide) (PPS), polysulfone (PSU), polyether imide (PEI) can also be used for the plastomeric sleeve.

As mentioned earlier, the body of a valve according to the invention may be in one piece or in several parts, in particular in two parts. When the valve comprises a valve body in one piece and a plastomeric sleeve, the latter is advantageously in two parts, which enables easy mounting of the valve as described in the previous examples, by sliding a first part of the sleeve in the bore of the body from a first side of the body and connecting the second part of the sleeve with the first part on the second side of the body opposite the first side.

Moreover, in the previous examples, the valve has been described with a single drive shaft, which passes through the shutter element from top to bottom and is rotatably mounted at its upper and lower ends in necks of the valve body. Alternatively, a valve according to the invention may comprise a shaft made of several parts that fit together, or several separate shaft portions, with in this case a non-traversing shutter element. In particular, a valve according to the invention may comprise two separate shaft portions, namely an upper shaft portion connected to an upper portion of the shutter element and rotatably mounted in an upper neck of the valve body, on the one hand, and a lower shaft portion connected to a lower portion of the shutter element and rotatably mounted in a lower neck of the valve body, on the other hand.

Finally, a seal according to the invention can be used for other types of valves than the butterfly valves shown in the figures, in particular for off-axis butterfly valves, where the center of rotation of the shutter element is offset from the drive shaft, or for knife gate valves or ball valves. A seal according to the invention can also be used for other devices in which there are compressed and uncompressed regions of an elastomer.

1. A seal for a valve comprising a body and a shutter element movable in a bore of the body under an action of a drive shaft, the seal being intended to be positioned in the bore of the body and configured to ensure the sealing of the valve at the shaft passages, the seal comprising at least one elastomeric ring segment having a passage opening for the shaft, the elastomeric ring segment comprising a surrounding portion arranged around the passage opening and lateral arms which extend in the circumferential direction of the ring while being each connected to the surrounding portion, characterized in that, starting from each junction between the surrounding portion and a lateral arm, the surrounding portion flares outwardly in an axial direction (X-X′) of the ring relative to the lateral arm.

2. The seal according to claim 1, wherein an end of each lateral arm which is connected to the surrounding portion its width (l₈₆, l₈₈) in the axial direction (X-X′) of the ring which decreases towards the surrounding portion, the junction between the surrounding portion and the lateral arm being a throttle in the axial direction (X-X′) of the ring.

3. The seal according to claim 1, wherein the surrounding portion has a circular shape around the passage opening.

4. The seal according to claim 1, wherein the elastomeric ring segment has a constant thickness in a radial direction of the ring.

5. The seal according to claim 1, wherein the thickness of the surrounding portion in the radial direction of the ring is greater than that of each lateral arm.

6. The seal according to claim 1, wherein the seal comprises at least one washer arranged facing an outer surface of the surrounding portion.

7. (canceled)

8. The seal according to claim 1, wherein the or each elastomeric ring segment belongs to a complete elastomeric ring intended to be positioned in the bore of the body.

9. (canceled)

10. The seal according to claim 1, wherein the seal comprises an annular plastomeric sleeve having at least one shaft passage opening, the or each elastomeric ring segment surrounding an outer peripheral surface of the sleeve with the passage opening of the elastomeric ring segment facing the passage opening of the sleeve.

11. The seal according to claim 10, wherein the sleeve includes a collar projecting from its outer peripheral surface around the passage opening, the surrounding portion of the elastomeric ring segment surrounding the collar.

12. The seal according to claim 10, wherein the sleeve comprises a tubular portion intended to be positioned in the bore of the body, the tubular portion comprising:
a middle portion adapted to cooperate in a contiguous manner with the shutter element when it is in the closed position, and
two side portions on either side of the middle portion.
wherein the inner surface of each side portion has at least one surface portion (S), plane or curved, which is inclined with respect to the central axis of the tubular portion so as to come closer to the central axis towards the middle portion.

13. The seal according to claim 1, wherein the or each elastomeric ring segment is received in a groove whose side edges follow the shape of the contour of the elastomeric ring segment, the spacing between the side edges of the groove being configured so as to leave a free volume around the elastomeric ring segment in the axial direction (X-X′) of the ring.

14. The seal according to claim 13, wherein the groove is arranged on an outer peripheral surface of the sleeve.

15. The seal according to claim 13, wherein the groove (2) is arranged on an inner peripheral surface (31A) of the bore (31) of the body (3).

16. (canceled)

17. A seal for a valve comprising a body and a shutter element movable in a bore of the body under the action of a drive shaft, the seal comprising a plastomeric sleeve of which a tubular portion intended to be positioned in the bore of the body, the tubular portion comprising:
a middle portion adapted to cooperate in a contiguous manner with the shutter element when it is in the closed position, and
two side portions on either side of the middle portion wherein the inner surface of each side portion at least one surface portion (S), plane or curved, which is inclined with respect to the central axis of the tubular portion so as to come closer to the central axis towards the middle portion.

18. A valve comprising a valve body and a shutter element movable in a bore of the body under the action of a drive shaft, wherein the valve comprises a seal according to any one of the preceding claims, which is positioned in the bore of the body.
